(19) United States
(12) Patent Application Publication
(10) Pub. No.: US 2020/0195456 A1
(43) Pub. Date: Jun. 18, 2020

(54) RELAY AND PACKET TRANSFER METHOD

(71) Applicant: Mitsubishi Electric Corporation, Chiyoda-ku, Tokyo (JP)

(72) Inventors: Joji Ido, Tokyo (JP); Akikazu Yasui, Tokyo (JP)

(73) Assignee: Mitsubishi Electric Corporation, Chiyoda-ku, Tokyo (JP)

(21) Appl. No.: 16/472,977

(22) PCT Filed: Jan. 27, 2017
(86) PCT No.: PCT/JP2017/002979

§ 371 Date: Jun. 24, 2019

(51) Int. Cl. H04L 12/18; H04L 12/28; H04L 12/741; H04L 12/761; H04L 12/721

(52) U.S. Cl. CPC H04L 12/185; H04L 12/28; H04L 45/566; H04L 45/16; H04L 45/74

(57) ABSTRACT

A relay that controls packet transfer includes: a storage that stores output cycle control information in which an output cycle at which a packet identified by identification information is output, and a determination value indicating whether to output the packet identified by the identification information are set for a set of a port as an output destination of the packet and the identification information for identifying the packet; a cycle controller that rewrites the determination value at each set output cycle; and a transfer processor that controls output of the received packet, in accordance with the determination value.

### FIELD

The present invention relates to a relay that controls packet transfer, and a packet transfer method.

### BACKGROUND

Car information management devices of a train periodically acquire state data from a monitor-control target device that is a device or the like installed in a train car. The car information management devices include a control device that controls operation of the monitor-control target device, and a monitor device that monitors the state of the monitor-control target device. Normally, the control device and the monitor device require different state data cycles. The control device uses state data in performing control, and therefore, needs to acquire state data at a short cycle. On the other hand, the monitor device acquires state data at a longer cycle than the cycle at which the control device acquires state data. The monitor-control target device transmits a packet containing state data by multicast at the shorter update cycle required by the control device. The control device and the monitor device each receive and register a multicast address, and then receive the multicast packet including the state data. At this point of time, the monitor device is forced to receive the multicast packet at a shorter cycle than the needed cycle, and load for the central processing unit (CPU) increases due to the packet reception process.

Patent Literature 1 discloses a technique for preventing an Ethernet (registered trademark) system from breaking down in a hub, by setting a data amount to be allowed for transmission in a certain cycle for each connected terminal device, and issuing a transmission stop instruction to a terminal device in a case where the amount of data transmitted from the terminal device exceeds the set data amount as a result of monitoring of data amounts.

### CITATION LIST

### Patent Literature

Patent Literature 1: Japanese Patent Application Laid-open No. 2000-92109

### SUMMARY

### Technical Problem

According to the above conventional technique, however when the amount of transmitted data exceeds the set data amount, the terminal device that is the transmission source of the data stops the transmission itself. As a result, data transmission to a device that requires data at short cycles is also stopped.

The present invention has been made in view of the above, and aims to obtain a relay capable of controlling the frequency of transfer of a received packet.

### Solution to Problem

To solve the above problem and achieve the object, the present invention is a relay that controls packet transfer. The relay includes: a storage that stores output cycle control information in which an output cycle at which a packet identified by identification information is output, and a determination value indicating whether to output the packet identified by the identification information are set for a set of a port as an output destination of the packet and the identification information for identifying the packet; a cycle controller that rewrites the determination value at each set output cycle; and a transfer processor that controls output of the received packet, in accordance with the determination value.

### Advantageous Effects of Invention

According to the present invention, it is possible to control the transfer frequency of the received packet.

### BRIEF DESCRIPTION OF DRAWINGS

FIG. 1 is a diagram illustrating an example configuration of a car control information system including a relay.

FIG. 2 is a diagram illustrating an example of output cycle control information stored in a storage of the relay.

FIG. 3 is a flowchart illustrating an operation in which a cycle controller sets and stores output cycle control information into a storage.

FIG. 4 is a flowchart illustrating an operation in which the cycle controller rewrites the value of an output number counter in the output cycle control information stored in the storage when a timer expires.

FIG. 5 is a flowchart illustrating a packet transfer control operation by a transfer processor.

FIG. 6 is a diagram illustrating an example case where the processing circuit of the relay is formed with a CPU and a memory.

FIG. 7 is a diagram illustrating an example case where the processing circuit of the relay is formed with dedicated hardware.

### DESCRIPTION OF EMBODIMENTS

The following is a detailed description of a relay and a packet transfer method according to an embodiment of the present invention, with reference to the drawings. It should be noted that the present invention is not limited by this embodiment.

### Embodiment

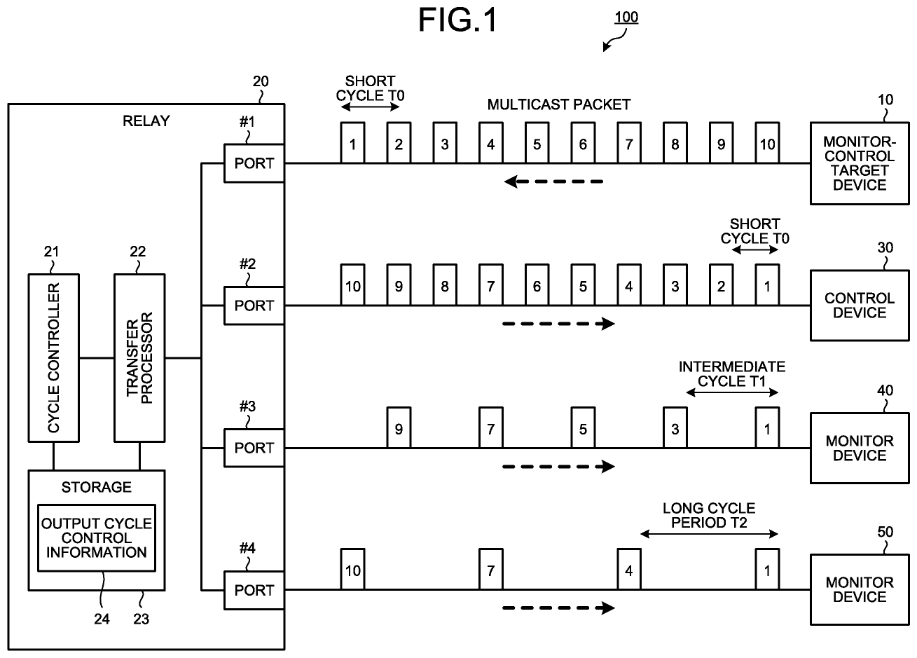

FIG. 1 is a diagram illustrating an example configuration of a car control information system (a train control and monitoring system: TCMS) 100 that includes a relay 20 according to an embodiment of the present invention. The car control information system 100 includes a monitor-control target device 10, the relay 20, a control device 30, and monitor devices 40 and 50. Each of the monitor-control target device 10, the relay 20, the control device 30, and the monitor devices 40 and 50 is a device installed in a train.

The monitor-control target device 10 is a device installed in each of the cars constituting the train, and is a brake, an air conditioner, a door, or the like, for example. The monitor-control target device 10 incorporates state data indicating its own state into a multicast packet, and transmits the multicast packet at cycles of a short cycle T0. For example, the state data is information indicating an operation mode such as cooling or heating, a set temperature, and the like in a case where the monitor-control target device 10 is an air conditioner, and is information indicating an opened/closed state, presence/absence of a failure, and the like in a case where the monitor-control target device 10 is a door.

The control device 30 is a device that controls operation of the monitor-control target device 10, and issues an instruction to the monitor-control target device 10, in accordance with the state data included in the multicast packet acquired from the monitor-control target device 10 via the relay 20.

The monitor devices 40 and 50 are devices that monitor the state of the monitor-control target device 10, in accordance with the state data included in the multicast packet acquired from the monitor-control target device 10 via the relay 20. For example, the monitor devices 40 and 50 are devices that accumulate state data for later analysis, devices that displays the current operating state of the monitor-control target device 10, devices that transmits the state data of the monitor-control target device 10 to a device on the ground, and the like.

The relay 20 performs control to transfer the multicast packet received from the monitor-control target device 10 to the control device 30 and the monitor devices 40 and 50, on the basis of a set output cycle.

The car control information system 100 may be designed to have the monitor-control target device 10, the relay 20, the control device 30, and the monitor devices 40 and 50 installed in each car, or may be designed to have the monitor-control target device 10 and the relay 20 installed in each car while having the control device 30 and the monitor devices 40 and 50 installed in a particular car such as the first car of the train.

Generally, to control operation of the monitor-control target device 10, the control device 30 preferably receives state data from the monitor-control target device 10 in real time, or receives a multicast packet with short cycle T0.

In a case where the monitor devices 40 and 50 are devices that display the operating state of the monitor-control target device 10, however, if the monitor devices 40 and 50 frequently receive a multicast packet with short cycle T0, the load for the CPU increases due to the process of receiving multicast packets, and might adversely affect the display process. Receiving multicast packets at display update cycles is sufficient for the monitor devices 40 and 50. Further, in a case where the monitor devices 40 and 50 are devices that transmit state data to a device on the ground, if the monitor devices 40 and 50 frequently receive a multicast packet with short cycle T0, the load for the CPU increases due to the process of receiving multicast packets, and might adversely affect the transmission process. Receiving multicast packets at state data transmission cycles is sufficient for the monitor devices 40 and 50. With the loads for the CPU of the monitor devices 40 and 50 being taken into consideration, the monitor devices 40 and 50 may preferably receive state data, or a multicast packet, with intermediate cycle T1 that is longer than the short cycle T0, or with long cycle T2 that is even longer than the intermediate cycle T1.

Therefore, in the present embodiment, the monitor-control target device 10 transmits a multicast packet including state data to the relay 20 with short cycle T0, and the relay 20 performs control to transfer a multicast packet to the control device 30 and the monitor devices 40 and 50 on the basis of output cycles set for the ports to which the respective devices are connected.

The configuration and operation of the relay 20 are now specifically described. As illustrated in FIG. 1, the relay 20 includes four ports #1 through #4, a cycle controller 21, a transfer processor 22, and a storage 23.

In the relay 20, the monitor-control target device 10 is connected to the port #1, the control device 30 is connected to the port #2, the monitor device 40 is connected to the port #3, and the monitor device 50 is connected to the port #4. Referring to FIG. 1, a case where the relay 20 receives a multicast packet transmitted from the monitor-control target device 10 at the port #1, and transfers the received multicast packet from the ports #2 through #4 is described as an example. It should be noted that, in the relay 20, each of the ports #1 through #4 is a port capable of transmitting and receiving packets. For example, the relay 20 can receive, at the port #2, a packet that is transmitted from the control device 30 and includes an instruction directed to the monitor-control target device 10, and can transfer the received packet to the monitor-control target device 10 from the port #1.

For each entry, the cycle controller 21 sets: output cycle control information 24 that includes the output cycle at which the packet identified by identification information is to be output; and a determination value indicating whether to output the packet identified by the identification information, for a set of the packet output destination port and the identification information for identifying the packet. The cycle controller 21 then causes the storage 23 to store the set output cycle control information 24. It should be noted that the identification information set in the output cycle control information 24 is the identification information about a packet for which transfer control is to be performed at one of the ports #1 through #4. Packets for which transfer control is not to be performed at any of the ports #1 through #4 are transferred as usual, and therefore, the identification information about such packets is not set in the output cycle control information 24. Here, performing transfer control means transferring a received multicast packet at a longer cycle than the cycle at which the multicast packet was received, or decimating and then transferring the received multicast packet. Performing no transfer control means transferring a received multicast packet at the same cycle as the cycle at which the multicast packet was received, or transferring the received multicast packet without decimation.

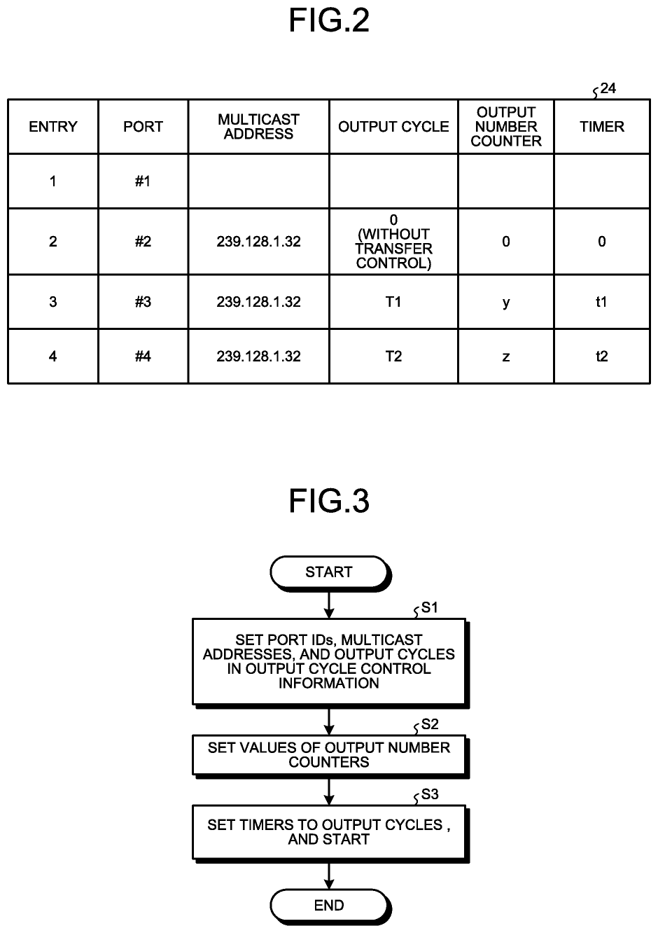

FIG. 2 is a diagram illustrating an example of the output cycle control information 24 stored in the storage 23 of the relay 20 according to the present embodiment. In the output cycle control information 24 in the example illustrated in FIG. 2, items such as a port, a multicast address, an output cycle, an output number counter, and a timer are set for each entry. The output cycle control information 24 illustrated in FIG. 2 indicates the contents of the control to be performed when the relay 20 transfers, from the ports #2 through #4, the multicast packet represented by a multicast address “239.128.1.32” received from the monitor-control target device 10 connected to the port #1. The fields for the port #1 that receives the multicast packet represented by the multicast address “239.128.1.32” are blank, because the transfer is not performed from the port #1. However, information indicating that transfer is not to be performed may be set in the fields.

It should be noted that sets of a packet output destination port and identification information that can be set in the output cycle control information 24 are not limited to the ones illustrated in the example of FIG. 2. Although not illustrated in FIG. 2, the items of an output cycle, an output number counter, and a timer can be set for sets of a packet output destination port and a different multicast address from the multicast address “239.128.1.32”, for entry 5 or the subsequent entries. Further, different cycles from the short cycle T0, the intermediate cycle T1, and the long cycle T2, such as cycles T3 and T4, may be set as the output cycles for sets of a packet output destination port and a different multicast address from the multicast address “239.128.1.32”. Since a plurality of multicast addresses, or pieces of identification information, can be set for one port in the output cycle control information 24, it is also possible to set different output cycles, or a plurality of output cycles, for each piece of identification information at one port.

In the output cycle control information 24 illustrated in FIG. 2, a multicast address is specifically set as the identification information for identifying a packet. However, this is merely an example, and embodiments are not limited thereto. The identification information for identifying a packet may be the information attached to the header of the packet, such as information about the source address of the device that transmitted the packet, or information about the type of the packet, for example.

Further, in the output cycle control information 24 illustrated in FIG. 2, “0” is set for the port #2, “T1” is set for the port #3, and “T2” is set for the port #4, as the output cycles. The output cycle “0” means that the packet transfer control is not to be performed for this port. That is, the output cycle control information 24 illustrated in FIG. 2 indicates that the relay 20 outputs the multicast packet represented by the multicast address “239.128.1.32” from the port #2 at the cycle of the short cycle T0, which is the same as the cycle at which the multicast packet was received from the port #1. It should be noted that the output cycle for a port not performing packet transfer control is not necessarily “0”, but a value indicating that transfer control is not to be performed may be provided, and this value indicating that transfer control is not to be performed may be set. The output cycle control information 24 illustrated in FIG. 2 also indicates that the relay 20 outputs the multicast packet represented by the multicast address “239.128.1.32” from the port #3 at the cycle of the intermediate cycle T1, which is longer than the short cycle T0, and outputs the multicast packet from the port #4 at the cycle of the long cycle T2, which is longer than the intermediate cycle T1.

For each packet to be subjected to transfer control at one of the ports of the relay 20, packet identification information is set in the output cycle control information 24. However, it is not necessary to perform transfer control at all the ports either in this case. For a port at which there is no need to perform transfer control, “0” should be set as the output cycle. This enables the relay 20 to flexibly perform transfer control on various kinds of packets.

Further, in the output cycle control information 24 illustrated in FIG. 2, the value of each output number counter that is “0” or a natural number is set as the determination value indicating whether to output the packet identified by the identification information. In the example in FIG. 2, “0” is set for the port #2, “y” is set for the port #3, and “z” is set for the port #4. The value of each output number counter is a value that can be rewritten by the cycle controller 21 and the transfer processor 22. It should be noted that “0” is set as the value of the output number counter for the port #2 that has the output cycle set at “0” and has no packet transfer control to be performed therein. As for the values of “y” and “z”, different values other than “0” may be set, or the same value such as “1” may be set. As “y” and “z” are to be rewritten independently of each other, different values are set in FIG. 2.

The cycle controller 21 activates the timer, and, for the port #3, rewrites the value of the output number counter from “y” to “0” for every intermediate cycle T1, which is the output cycle set in the output cycle control information 24. Likewise, for the port #4, the cycle controller 21 rewrites the value of the output number counter from “z” to “0” every long cycle T2, which is the output cycle set in the output cycle control information 24. The cycle controller 21 may include the timer therein, or may use a timer (not illustrated) outside the cycle controller 21 in the relay 20 illustrated in FIG. 1. The values “y” and “z” of output number counters are set as first values with which the multicast packet represented by the multicast address “239.128.1.32” is not to be output. Meanwhile, the value “0” of an output number counter is set as a second value with which the multicast packet represented by the multicast address “239.128.1.32” is to be output.

In a case where the value of the output number counter for the port #3 is “0”, when a multicast packet is output from the port #3, the transfer processor 22 rewrites the value of the output number counter for the port #3 in the output cycle control information 24 from “0” to “y”. Likewise, in a case where the value of the output number counter for the port #4 is “0”, when a multicast packet is output from the port #4, the transfer processor 22 rewrites the value of the output number counter for the port #4 in the output cycle control information 24 from “0” to “z”.

The timer shown in the output cycle control information 24 in FIG. 2 indicates the remaining time in the output cycle for each port at which counting is being performed by the cycle controller 21 using a timer. However, each timer shown in the output cycle control information 24 does not necessarily indicate a remaining time, but may indicate an elapsed time. As for the port #2, the output cycle is “0”, or transfer control is not to be performed. Therefore, “0” is set in the field of the timer.

In the operation to set and store the output cycle control information 24 into the storage 23, the cycle controller 21 may set the output cycle control information 24 using information that is input from the user through an operation unit not illustrated in FIG. 1 or an external device, or may set the output cycle control information 24 by receiving output cycle information from the control device 30 and the monitor devices 40 and 50.

The operation of the cycle controller 21 described above is now described with reference to a flowchart. FIG. 3 is a flowchart illustrating an operation in which the cycle controller 21 according to the present embodiment sets and stores the output cycle control information 24 into the storage 23. In the description below, a case where settings have been received from the user is explained as an example. Upon receiving port IDs (identifications), multicast addresses, and output cycles to be set in the output cycle control information 24 from the user, the cycle controller 21 sets these items in the output cycle control information 24 for respective entries, and stores the output cycle control information 24 into the storage 23 (step S1). The port IDs are for identifying the ports #1 through #4, and are shown as “PORT” in FIG. 2.

The cycle controller 21 sets the values of the output number counters (step S2). Specifically, the cycle controller 21 sets a value that is not “0” as the value of the output number counter for a port whose output cycle is greater than “0”, or a port at which transfer control is to be performed. The cycle controller 21 sets the value “0” as the value of the output number counter for a port whose output cycle is “0”, or a port at which transfer control is not to be performed.

The cycle controller 21 sets timers in the output cycle control information 24, and starts the timers (step S3). It should be noted that the cycle controller 21 sets the timer to “0” for a port at which transfer control is not to be performed, but does not start the timer.

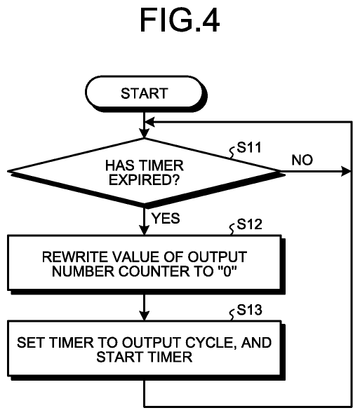

FIG. 4 is a flowchart illustrating an operation in which the cycle controller 21 according to the present embodiment rewrites the value of an output number counter in the output cycle control information 24 stored in the storage 23 when the timer expires. The cycle controller 21 performs the operation in the flowchart illustrated in FIG. 4 for each entry as the target of a port at which packet transfer control is to be performed in the output cycle control information 24.

The cycle controller 21 checks whether the timer set for a port at which packet transfer control is to be performed has expired (step S11). The cycle controller 21 stands by until the timer expires (step S11: No). When the timer expires (step S11: Yes), the cycle controller 21 rewrites the value of the output number counter to “0” (step S12). The cycle controller 21 sets the timer to the output cycle, and starts the timer (step S13). It should be noted that the operation of the cycle controller 21 illustrated in FIG. 4 is a first rewriting step in the relay 20.

The description now returns to explanation of the configuration of the relay 20. As described above, the storage 23 stores the output cycle control information 24 set by the cycle controller 21. The storage 23 may store the output cycle control information 24 in a table format as illustrated in FIG. 2, or may store the output cycle control information 24 in some other formats.

The transfer processor 22 controls an output of a received packet, in accordance with the values of the output number counters in the output cycle control information 24 stored in the storage 23. Specifically, after receiving the packet corresponding to a multicast packet set in the output cycle control information 24, the transfer processor 22 outputs the received packet from a port having “0” as the value of the output number counter, and does not output the received packet from any port not having “0” as the value of the output number counter, in accordance with the output cycle control information 24. The transfer processor 22 also rewrites the value of the output number counter of the entry corresponding to the port from which the packet has been output in the output cycle control information 24, from “0” to the original value, which is a value other than “0”. The original value is “y” or “z” in the example in FIG. 2.

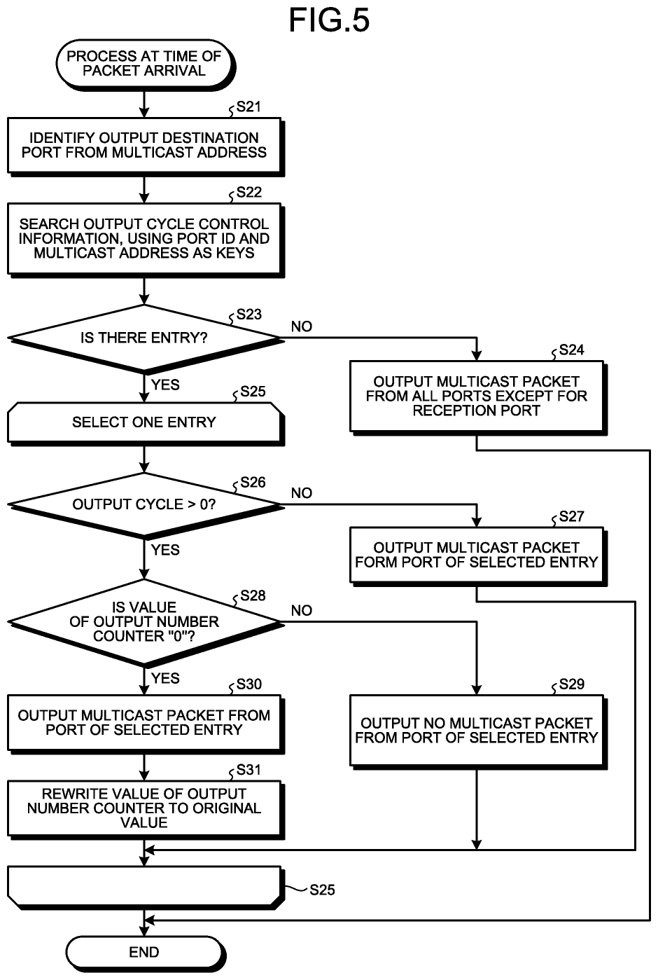

The operation of the transfer processor 22 is now described in detail, with reference to a flowchart. FIG. 5 is a flowchart illustrating a packet transfer control operation to be performed by the transfer processor 22 according to the present embodiment. Upon receiving a multicast packet from a port, the transfer processor 22 identifies the output destination port from the multicast address of the multicast packet (step S21).

Using the port ID of the port corresponding to the output destination port and the multicast address as keys, the transfer processor 22 searches the output cycle control information 24 in the storage 23 (step S22). That is, the transfer processor 22 determines whether the received multicast packet is to be subjected to transfer control. If there is no setting information, or no relevant entries, in the output cycle control information 24 as a result of the search (step S23: No), the transfer processor 22 outputs the received multicast packet from all the ports except for the port from which the multicast packet was received (step S24), and ends the operation.

If there is the setting information, or the relevant entries, in the output cycle control information 24 as a result of the search (step S23: Yes), the transfer processor 22 selects one entry to be subjected to transfer control (step S25). In the example of the output cycle control information 24 illustrated in FIG. 2, the transfer processor 22 sequentially selects each of entries 2 through 4 as an entry to be subjected to transfer control. If the output cycle of the port of the selected entry is “0” (step S26: No), the transfer processor 22 outputs the multicast packet from the port of the selected entry (step S27). In the example of the output cycle control information 24 illustrated in FIG. 2, the port #2 of entry 2 corresponds to the case where the result of step S26 is “No”.

If the output cycle of the port of the selected entry is greater than “0” (step S26: Yes), the transfer processor 22 checks whether the value of the output number counter is “0” (step S28). In the example of the output cycle control information 24 illustrated in FIG. 2, the ports #3 and #4 of entries 3 and 4 correspond to the case where the result of step S26 is “Yes”.

If the value of the output number counter is not “0” (step S28: No), the transfer processor 22 does not output the multicast packet from the port of the selected entry (step S29). If the value of the output number counter is “0” (step S28: Yes), the transfer processor 22 outputs the multicast packet from the port of the selected entry (step S30). The transfer processor 22 rewrites the value of the output number counter of the entry corresponding to the port from which the multicast packet has been output in the output cycle control information 24, from “0” to the original value (step S31). The transfer processor 22 rewrites the value of the output number counter from “0” to “y” in a case where the multicast packet has been output from the port #3, and rewrites the output number counter from “0” to “z” in a case where the multicast packet has been output from the port #4. As for “y” and “z”, both values may be “1” as described above.

In step S25, if there is an entry that has not been selected as an entry to be subjected to transfer control, the transfer processor 22 selects an entry that has not been selected as an entry to be subjected to transfer control, and performs the process in steps S26 through S31. In step S25, if there is no longer an entry that has not been selected as an entry to be subjected to transfer control, or if transfer control has been performed on the ports of all the entries that are the targets of transfer control, the transfer processor 22 ends the operation. It should be noted that, in the operation of the transfer processor 22 illustrated in FIG. 5, the process in steps S21 through step S30 is a transfer control step in the relay 20, and the process in step S31 is a second rewriting step in the relay 20.

In the relay 20, the cycle controller 21 rewrites the value of the output number counter to “0” in each output cycle of each port set in each entry, and the transfer processor 22 outputs a multicast packet from a port having “0” as the value of the output number counter, and rewrites the value of the output number counter of the port from which the multicast packet has been output, from “0” to the original value. Thus, the relay 20 can transfer a packet from each port in each set output cycle, without being affected by the packet reception cycle.

Specifically, upon receipt of a multicast packet at the port #1 from the monitor-control target device 10 at a cycle of the short cycle T0, the relay 20 outputs the multicast packet from the port #2 at which transfer control is not to be performed to the control device 30 at a cycle of the short cycle T0, as illustrated in FIG. 1. On the other hand, upon receipt of a multicast packet at the port #1 from the monitor-control target device 10 at a cycle of the short cycle T0, the relay 20 outputs the multicast packet from the port #3 at which transfer control is to be performed to the monitor device 40 at a cycle of the intermediate cycle T1, which is ½ of the frequency of the short cycle T0. Further, upon receipt of a multicast packet at the port #1 from the monitor-control target device 10 at a cycle of the short cycle T0, the relay 20 outputs the multicast packet from the port #4 at which transfer control is to be performed to the monitor device 50 at a cycle of the long cycle T2, which is ⅓ of the frequency of the short cycle T0.

As the monitor device 40 can receive a multicast packet at a cycle of the intermediate cycle T1, which is ½ of the frequency of the short cycle T0, the increase in the load for the CPU due to multicast packet reception can be reduced. Likewise, as the monitor device 50 can receive a multicast packet at a cycle of the long cycle T2, which is ⅓ of the frequency of the short cycle T0, the increase in the load for the CPU due to multicast packet reception can be further reduced.

Next, the hardware configuration of the relay 20 will be described. In the relay 20, the ports #1 through #4 are achieved with an interface circuit that transmits and receives packets. The storage 23 is achieved with a memory. The cycle controller 21 and the transfer processor 22 are achieved with a processing circuit. That is, the relay 20 includes a processing circuit for transferring packets at the output cycles for the respective ports. The processing circuit may be a CPU that executes a program stored in a memory, and the memory, or may be dedicated hardware.

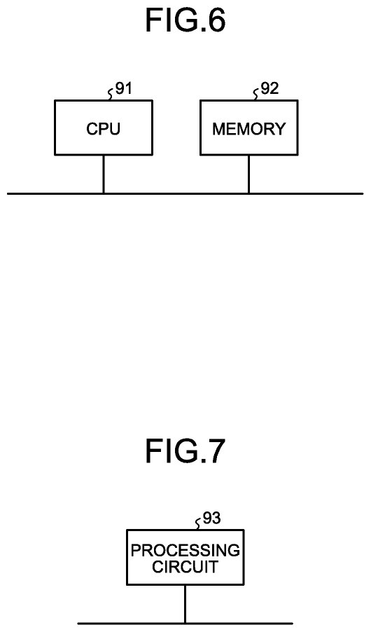

FIG. 6 is a diagram illustrating an example case where the processing circuit of the relay 20 according to the present embodiment is achieved with a CPU and a memory. In a case where the processing circuit is achieved with a CPU 91 and a memory 92, each function of the processing circuit of the relay 20 is achieved with software, firmware, or a combination of software and firmware. Software or firmware is written as a program, and is stored in the memory 92. In the processing circuit, the CPU 91 reads out and executes the program stored in the memory 92, to achieve the respective functions. That is, in the relay 20, the processing circuit includes the memory 92 for storing a program with which packet transfer will be eventually performed at the output cycles of the respective ports. These programs can also be regarded as programs for causing a computer to carry out the procedures and the method of the relay 20. Here, the CPU 91 may be a processing device, an arithmetic device, a microprocessor, a microcomputer, a processor, a digital signal processor (DSP), or the like. Meanwhile, the memory 92 may be a nonvolatile or volatile semiconductor memory such as a random access memory (RAM), a read only memory (ROM), a flash memory, an erasable programmable ROM (EPROM), or an electrically EPROM (EEPROM (registered trademark)), a magnetic disk, a flexible disk, an optical disk, a compact disc, a mini disc, a digital versatile disc (DVD), or the like, for example. The memory 92 may be the same as the memory that forms the storage 23.

FIG. 7 is a diagram illustrating an example case where the processing circuit of the relay 20 according to the present embodiment is configured by dedicated hardware. In a case where the processing circuit is dedicated hardware, a processing circuit 93 illustrated in FIG. 7 can be a single circuit, a composite circuit, a programmed processor, a parallel-programmed processor, an application specific integrated circuit (ASIC), a field programmable gate array (FPGA), or a combination thereof, for example. The respective functions of the relay 20 may be achieved with the processing circuit 93 independently of one another, or the respective functions may be collectively achieved with the processing circuit 93.

It should be noted that some of the functions of the relay 20 may be achieved with dedicated hardware, and the others may be achieved with software or firmware. In this manner, the processing circuit can achieve the above described functions with dedicated hardware, software, firmware, or a combination thereof.

As described above, according to the present embodiment, the relay 20 transmits a multicast packet received from the monitor-control target device 10, from the respective ports at the respective set output cycles, in accordance with the output cycles set for the respective ports. In this manner, the relay 20 can control the frequency of transfer of received packets. Accordingly, in the monitor devices 40 and 50 that receive multicast packets from the relay 20 can receive the multicast packet at a cycle of a longer cycle than the short cycle T0 for the monitor-control target device 10 to transmit a multicast packet. Thus, the increase in the load for the CPU can be reduced. As the output cycles taking the loads for the CPU of the monitor devices 40 and 50 into account are set in the relay 20, the relay 20 can continuously output multicast packets to the monitor devices 40 and 50 at regular cycles.

Further, the relay 20 outputs a multicast packet received from the monitor-control target device 10 to the monitor devices 40 and 50 after performing decimation at regular cycles, instead of smoothing the output timing by storing the multicast packet in a queue or the like and outputting the multicast packet after a certain period of time. Thus, the monitor devices 40 and 50 can acquire the latest state data included in the received multicast packet.

In the present embodiment described above, the relay 20 is used in the car control information system 100. However, the present embodiment is not limited to this. The relay 20 can also be applied to a system in which multicast packets are transmitted and received, other than the car control information system 100.

The configuration described in the above embodiment shows one example of the subject matter of the present invention and may be combined with another known technique, and it is possible to omit or modify part of the configuration, without departing from the scope of the present invention.

### REFERENCE SIGNS LIST

10 monitor-control target device;
20 relay;
21 cycle controller;
22 transfer processor;
23 storage;
24 output cycle control information;
30 control device;
40, monitor device;
100 car control information system;
#1 to #4 port.

1. A relay that controls packet transfer, the relay comprising:
a storage to store output cycle control information in which an output cycle at which a packet identified by identification information is output, and a determination value indicating whether to output the packet identified by the identification information are set for a set of a port as an output destination of the packet and the identification information for identifying the packet, wherein in the cycle control information a plurality of pieces of identification information and a plurality of output cycles can be set for one port;
a cycle controller to rewrite the determination value at each set output cycle; and
a transfer processor to control output of the received packet, in accordance with the determination value.

2. The relay according to claim 1, wherein,
in accordance with the output cycle control information, the cycle controller rewrites the determination value from a first value for not outputting the packet identified by the identification information to a second value for outputting the packet identified by the identification information in each set output cycle, for each set of the port and the identification information, and,
when the transfer processor receives the packet corresponding to the identification information set in the output cycle control information, the transfer processor outputs the received packet from a port having the second value as the determination value, and rewrites the determination value corresponding to the port from which the packet has been output in the output cycle control information from the second value to the first value, in accordance with the output cycle control information.

3. The relay according to claim 2, wherein
the transfer processor does not output the received packet from a port having the first value as the determination value.

4. The relay according to claim 2, wherein,
in the output cycle control information, for a port at which transfer control is not to be performed on the received packet, the output cycle is set at a value indicating that transfer control is not to be performed, and the determination value is the second value.

5. A packet transfer method for a relay that controls packet transfer, the packet transfer method comprising:
a first rewriting in which, for each set of a port and identification information, a cycle controller rewrites a determination value from a first value for not outputting a packet identified by the identification information to a second value for outputting the packet identified by the identification information at each set output cycle, in accordance with output cycle control information in which an output cycle at which the packet identified by the identification information is output, and the determination value indicating whether to output the packet identified by the identification information are set for a set of a port as an output destination of the packet and the identification information for identifying the packet, wherein in the cycle control information a plurality of pieces of identification information and a plurality of output cycles can be set for one port;
a transfer controlling in which, when a transfer processor receives the packet corresponding to the identification information set in the output cycle control information, the transfer processor outputs the received packet from a port having the second value as the determination value, in accordance with the output cycle control information; and
a second rewriting in which the transfer processor rewrites the determination value corresponding to the port from which the packet has been output in the output cycle control information, from the second value to the first value.

6. The relay according to claim 3, wherein,
in the output cycle control information, for a port at which transfer control is not to be performed on the received packet, the output cycle is set at a value indicating that transfer control is not to be performed, and the determination value is the second value.
